(19) United States
(12) Patent Application Publication
(10) Pub. No.: US 2020/0244580 A1
(43) Pub. Date: Jul. 30, 2020

(54) AUTOMATED RECOVERY FROM NETWORK TRAFFIC CONGESTION

(71) Applicant: Hewlett Packard Enterprise Development LP, Houston, TX (US)

(72) Inventors: Vijay Chakravarthy Gilakala, Bangalore (IN); Aravind Badiger, Bangalore (IN)

(21) Appl. No.: 16/260,580

(22) Filed: Jan. 29, 2019

(51) Int. Cl. H04L 12/803; H04L 12/741; H04L 12/721; H04L 12/707; H04L 12/24; H04L 12/751

(52) U.S. Cl. CPC H04L 47/122; H04L 45/745; H04L 45/02; H04L 45/22; H04L 41/0213; H04L 45/66

(57) ABSTRACT

A computing device includes a processor and a medium storing instructions executable to: detect a pause condition at a first port of a network switch, wherein the first port is included in a first path transmitting data between a first device and a second device, and wherein a first entry of a media access control (MAC) table of the network switch specifies an association between a MAC address of the second device and the first port; in response to a detection of the pause condition, determine a second path between the first device and the second device based on a network topology, wherein the second path includes a second port of the network switch; and directly modify the first entry of the MAC table to specify an association between the MAC address of the second device and the second port.

### BACKGROUND

A computing network can include any number of devices connected by data links. Some computing networks may be specialized to perform specific types of tasks. For example, a Storage Area Network (SAN) is generally configured to enable access to data storage devices such as disk arrays, tape libraries, jukeboxes, etc.

### BRIEF DESCRIPTION OF THE DRAWINGS

Some implementations are described with respect to the following figures.

FIG. 1 is a schematic diagram of an example system, in accordance with some implementations.

FIG. 2 is an illustration of an example system, in accordance with some implementations.

FIGS. 3A-3B are illustrations of example data structures, in accordance with some implementations.

FIG. 4 is an illustration of an example process, in accordance with some implementations.

FIG. 5 is a schematic diagram of an example computing device, in accordance with some implementations

FIG. 6 is a diagram of an example machine-readable medium storing instructions in accordance with some implementations.

### DETAILED DESCRIPTION

In information technology (IT) systems, computing devices may communicate via a network. For example, a sending device may transfer data to a receiving device using one of multiple paths in the network. However, the network path used to transfer data may become congested in an unexpected manner, and could thus suffer loss of data. For example, the amount of data transferred may cause a data queue to become full, thereby resulting in dropped packets.

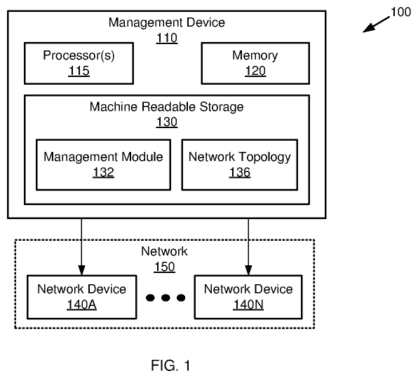

As described further below with reference to FIGS. 1-6, some implementations may provide automated recovery from network traffic congestion. In some examples, a management device may detect that a first data path between two devices is congested. In response, the management device may use a network topology to determine an alternative data path between the two devices. The management device may directly modify a media access control (MAC) table of a network switch so that packets sent to the destination MAC address are forwarded to a port on the alternative data path. In this manner, the congestion may be quickly and automatically addressed with minimal loss of packets. Accordingly, some implementations may provide improved automated recovery from network congestion.

FIG. 1 is a schematic diagram of an example system 100, in accordance with some implementations. In some examples, the system 100 may include a management device 110 to control any number of network devices 140A-140N (also referred to collectively as “network devices 140,” or individually as a “network device 140”) in a network 150. For example, the network devices 140 may include a switch, a bridge, a gateway, and so forth. In some implementations, the network 150 may include interconnections between the network devices 140 and one or more computing devices (not shown in FIG. 1), such as servers, desktop computers, appliances, and so forth.

In some implementations, the management device 110 may be a computing device including processor(s) 115, memory 120, and machine-readable storage 130. The processor(s) 115 can include a microprocessor, a microcontroller, a processor module or subsystem, a programmable integrated circuit, a programmable gate array, multiple processors, a microprocessor including multiple processing cores, or another control or computing device. The memory 120 can be any type of computer memory (e.g., dynamic random access memory (DRAM), static random-access memory (SRAM), etc.).

In some implementations, the machine-readable storage 130 can include non-transitory storage media such as hard drives, flash storage, optical disks, etc. As shown, the machine-readable storage 130 can include a management module 132 and a network topology 136. In some examples, the management module 132 may be implemented in executable instructions stored in the machine-readable storage 130 (e.g., software and/or firmware). However, the management module 132 can be implemented in any suitable manner. For example, some or all of the management module 132 could be hard-coded as circuitry included in the processor(s) 115 and/or the management device 110. In other examples, some or all of the management module 132 could be implemented on a remote computer (not shown), as web services, and so forth. In another example, the management module 132 may be implemented in one or more controllers of the management device 110.

In some implementations, the network topology 136 may be data representing the devices and configuration of the network 150. For example, the network topology 136 may include data identifying characteristics of the network devices 140, of connections to/from computing devices in the network 150 (not shown), and so forth. In some examples, the network topology 136 may store data in one or more organized structures (e.g., relational tables, extensible markup language (XML) files, flat files, and so forth).

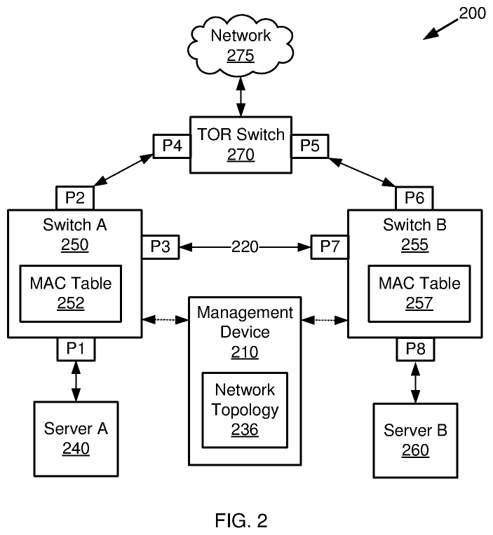

In one or more implementations, the management module 132 may detect a congested path across one or more network devices 140. In response to the detection, the management module 132 may use the network topology 136 to determine an alternative path in the network 150. Further, the management module 132 may modify one or more media access control (MAC) tables in the network devices 140 so that packets sent to a destination MAC address are automatically routed via the alternative path instead of the congested path. In this manner, the congestion may be addressed with minimal loss of packets. The functions of the management module 132 are discussed further below with reference to FIGS. 2-6.

Referring now to FIG. 2, shown is an example system 200, in accordance with some implementations. As shown, the system 200 may include a management device 210, server A 240, server B 260, switch A 250, switch B 255, Top of Rack (TOR) switch 270, and network 275. The system 200 may correspond generally to an example implementation of the system 100 (shown in FIG. 1). Note that the system 200 is not intended to limit implementations, and other variations are possible. In some examples, the system 200 may implement a Remote Direct Memory Access over Converged Ethernet (RoCE) protocol and/or Priority-based Flow Control (PFC). In some examples, Remote Direct Memory Access may provide access to memory on a remote machine without CPU intervention. Further, when traffic congestion is detected, PFC may use priority pause frames to control a traffic rate. However, other implementations are also possible.

In some examples, the switches 250, 255, 270 may include various communication ports P1-P8 to send/receive data. Assume that, at a first point in time, server A 240 and server B 260 have established communication via a first data path including ports P1, P2, P4, P5, P6, and P8. Accordingly, in some implementations, the MAC tables 252, 257 (of switch A 250 and switch B 255, respectively) may include entries indicating the forwarding port for MAC addresses of server A 240 and server B 260.

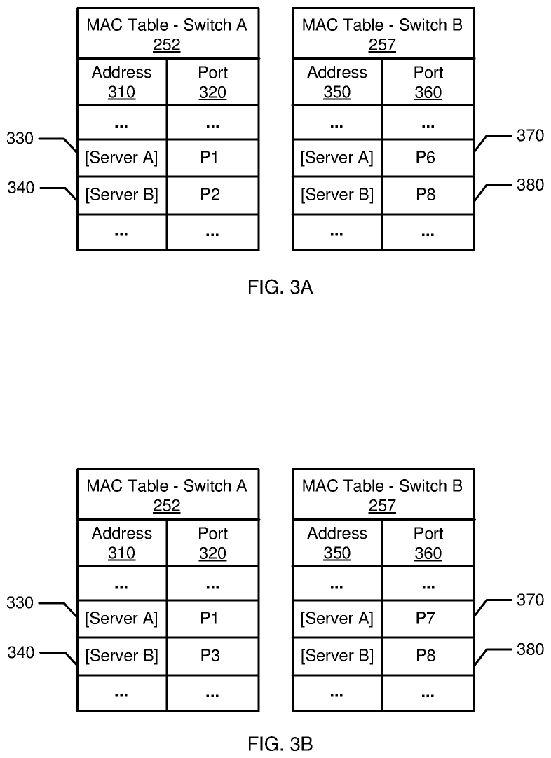

Referring now to FIG. 3A, shown are diagrams illustrating entries of the MAC tables 252, 257 at the first point in time in accordance to some implementations. In some examples, each entry of the MAC tables 252, 257 may define a port to be used to forward packets specifying a destination MAC address. For example, as shown in FIG. 3A, the entries of the MAC table 252 may each include a MAC address field 310 and a port field 320, and the entries of the MAC table 257 may each include a MAC address field 350 and a port field 360. The MAC table 252 (included in switch A) may include an entry 330 specifying that packets directed to the MAC address of Server A should be forwarded to port P1, and may include an entry 340 specifying that packets directed to the MAC address of Server B should be forwarded to port P2. Further, the MAC table 257 (included in switch B) may include an entry 370 specifying that packets directed to the MAC address of Server A should be forwarded to port P6, and may include an entry 380 specifying that packets directed to the MAC address of Server B should be forwarded to port P8.

Referring again to FIG. 2, assume that the management device 210 detects congestion in the first data path. For example, the management device 210 may be notified that one or more pause messages (e.g., priority pause frames) were received at port P2 of switch A 250 to indicate that port P4 of TOR switch 270 is congested, and thus port P2 may be put into a pause flood condition. In some implementations, a port may be put into a pause flood condition when the following are met: (1) egress queue length is non-zero for an entire sample period and not decreasing compared to previous sample, (2) the received port pause or priority pause count is increasing, and (3) transmit frame counters are not increasing compared to previous samples. Further, in some implementations, the switch A 250 may notify the management device 210 of the received pause message via a particular protocol or mechanism (e.g., Simple Network Management Protocol (SNMP)).

In one or more implementations, in response to detecting congestion in the first data path, the management device 210 may determine an alternative data path using a network topology 236. For example, the management device 210 may determine that switch A 250 is connected to switch B 255 via a stacking cable 220. Further, in some implementations, the management device 210 may directly modify the MAC tables 252, 257 to specify this alternative data path. For example, referring to FIG. 3B, shown are diagrams of the MAC tables 252, 257 at a second point in time in accordance to some implementations. As shown in FIG. 3B, entry 340 of MAC table 252 may have been modified (e.g., by the management device 210 shown in FIG. 2) to specify that packets directed to the MAC address of Server B should be forwarded to port P3 (i.e., connected to the stacking cable 220). Further, entry 370 of MAC table 257 may have been modified to specify that packets directed to the MAC address of Server A should be forwarded to port P7 (i.e., connected to the stacking cable 220). Thereafter, the packets transmitted between server A 240 and server B 260 are automatically routed via the alternative path, thus avoiding the congested original path. In this manner, recovery from traffic congestion may be rapidly provided with minimal loss of packets.

In one or more implementations, the management device 210 may determine whether the congestion in the first data path has been cleared. For example, the management device 210 may receive a notification (e.g., via a SNMP message from switch A 250) indicating that the pause condition at congestion of the first data path has been resolved. In another example, the management device 210 may periodically poll or access switch A 250 and/or TOR switch 270 to determine whether port P4 is no longer congested, and thus port P2 is taken out of a pause flood condition. In some implementations, in response to a determination that the congestion in the first data path has cleared, the management device 210 may determine to return to the first data path. For example, the management device 210 may modify the MAC tables 252, 257 to again specify the first data path.

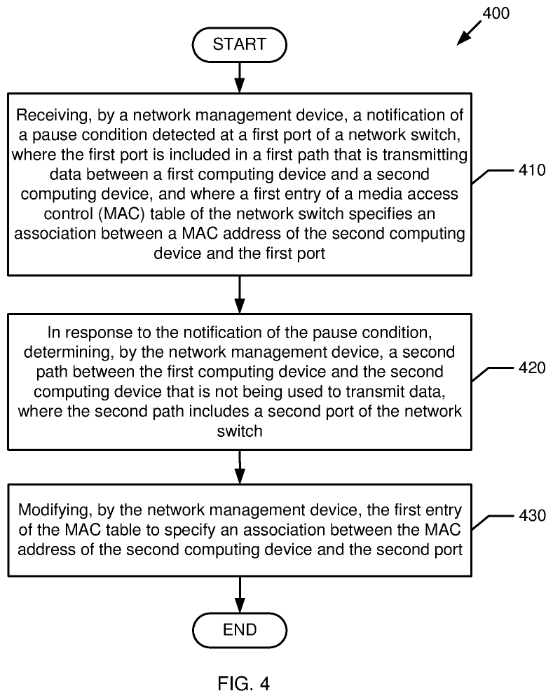

Referring now to FIG. 4, shown is an example process 400, in accordance with some implementations. In some examples, the process 400 may be performed by some or all of the system 100 (shown in FIG. 1) and/or the system 200 (shown in FIG. 2). The process 400 may be implemented in hardware and/or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3B, which show examples in accordance with some implementations. However, other implementations are also possible.

Block 410 may include receiving, by a network management device, a notification of a pause condition detected at a first port of a network switch, where the first port is included in a first path that is transmitting data between a first computing device and a second computing device, and where a first entry of a media access control (MAC) table of the network switch specifies an association between a MAC address of the second computing device and the first port. For example, referring to FIGS. 2-3A, the management device 210 may receive an SNMP message indicating that a pause message has been received at port P2 of switch A 250. The pause message may indicate that ports P4 and/or P5 are congested. The management device 210 may determine that ports P4 and P5 are included in a first data path between server A 240 and server B 260 (e.g., via ports P1, P2, P4, P5, P6, and P8). Further, an entry 340 of MAC table 252 (in switch A) specifies that packets directed to the MAC address of Server B 260 should be forwarded to port P2 (i.e., to follow the first data path).

Block 420 may include, in response to the notification of the pause condition, determining, by the network management device, a second path between the first computing device and the second computing device that is not being used to transmit data, where the second path includes a second port of the network switch. For example, referring to FIG. 2, the management device 210 may use the network topology 236 to determine that an alternative path exists via the stacking cable 220 between switch A 250 and switch B 255. As shown in FIG. 2, port P3 of switch A 250 is included in this alternative path.

Block 430 may include modifying, by the network management device, the first entry of the MAC table to specify an association between the MAC address of the second computing device and the second port. For example, referring to FIGS. 2 and 3B, the management device 210 may directly edit or overwrite the entry 340 of MAC table 252 (in switch A) to specify that packets directed to the MAC address of Server B 260 should be forwarded to port P3 (i.e., to follow the alternative path determined at block 420). Referring again to FIG. 4, after block 430, the process 400 may be completed.

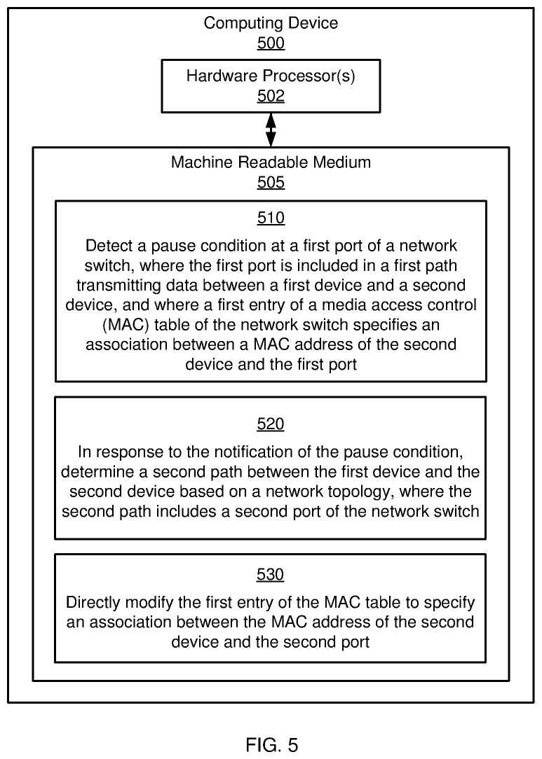

Referring now to FIG. 5, shown is a schematic diagram of an example computing device 500. In some examples, the computing device 500 may correspond generally to the management device 110 (shown in FIG. 1) and/or the management device 210 (shown in FIG. 2). As shown, the computing device 500 may include hardware processor(s) 502 and machine-readable storage medium 505 including instruction 510-530. The machine-readable storage medium 505 may be a non-transitory medium. The instructions 510-530 may be executed by the hardware processor(s) 502.

Instruction 510 may be executed to detect a pause condition at a first port of a network switch, where the first port is included in a first path transmitting data between a first device and a second device, and where a first entry of a media access control (MAC) table of the network switch specifies an association between a MAC address of the second device and the first port.

Instruction 520 may be executed to, in response to a detection of the pause condition, determine a second path between the first device and the second device based on a network topology (e.g., network topology 136 shown in FIG. 1), where the second path includes a second port of the network switch. Instruction 530 may be executed to directly modify the first entry of the MAC table of the network switch to specify an association between the MAC address of the second device and the second port.

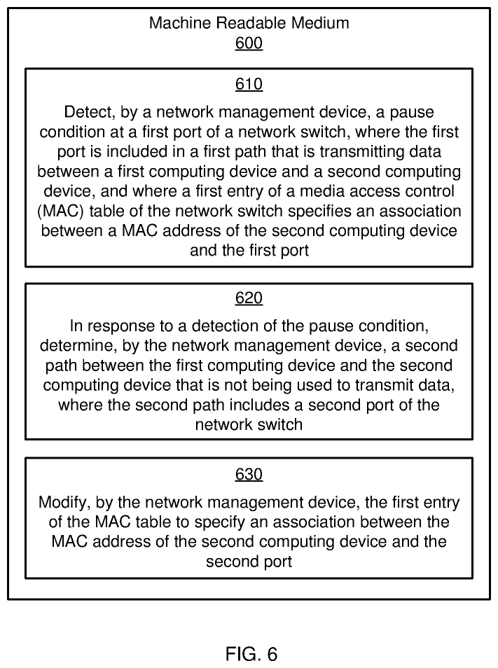

Referring now to FIG. 6, shown is machine-readable medium 600 storing instructions 610-630, in accordance with some implementations. The instructions 610-630 can be executed by any number of processors (e.g., the processor(s) 115 shown in FIG. 2). The machine-readable medium 600 may be a non-transitory storage medium, such as an optical, semiconductor, or magnetic storage medium.

Instruction 610 may be executed to detect, by a network management device, a pause condition at a first port of a network switch, where the first port is included in a first path that is transmitting data between a first computing device and a second computing device, and where a first entry of a media access control (MAC) table of the network switch specifies an association between a MAC address of the second computing device and the first port. Instruction 620 may be executed to, in response to a detection of the pause condition, determine, by the network management device, a second path between the first computing device and the second computing device that is not being used to transmit data, where the second path includes a second port of the network switch. Instruction 630 may be executed to modify, by the network management device, the first entry of the MAC table to specify an association between the MAC address of the second computing device and the second port.

Note that, while FIGS. 1-6 show various examples, implementations are not limited in this regard. For example, referring to FIGS. 1-2, it is contemplated that system 100 and/or system 200 may include additional devices, fewer devices, different devices, different components, different connection paths, different protocols, and so forth. In another example, it is contemplated that the primary path and/or the alternative path may include any number or type of switches, ports, connections, and so forth. In still another example, it is contemplated that the network topology 136 may be stored externally to the management device 110. In yet another example, it is contemplated that the MAC tables 252, 257 may have additional and/or different fields, may be replaced by a different forwarding data structure, and so forth. Other combinations and/or variations are also possible.

In accordance with some implementations, examples are provided for automated recovery of network traffic congestion. In some examples, a management device may detect that a first data path between two devices is congested. In response, the management device may use a network topology to determine an alternative data path between the two devices. The management device may directly modify media access control (MAC) table(s) of one or more network switch so that packets sent to the destination MAC address are forwarded to a port on the alternative data path. In this manner, the congestion may be quickly and automatically addressed with minimal loss of packets. Accordingly, some implementations may provide improved automated recovery from network congestion.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
a hardware processor; and
a machine-readable storage medium storing instructions, the instructions executable by the processor to:
detect a pause condition at a first port of a network switch, wherein the first port is included in a first path transmitting data between a first device and a second device, and wherein a first entry of a media access control (MAC) table of the network switch specifies an association between a MAC address of the second device and the first port;
in response to a detection of the pause condition, determine a second path between the first device and the second device based on a network topology, wherein the second path includes a second port of the network switch; and
directly modify the first entry of the MAC table to specify an association between the MAC address of the second device and the second port.

2. The computing device of claim 1, wherein the first path includes a third port of a second network switch, wherein the second network switch includes a second MAC table, and wherein a second entry of the second MAC table specifies an association between a MAC address of the first device and the third port of the second network switch.

3. The computing device of claim 2, wherein the second path includes a fourth port of the second network switch, and wherein the instructions are executable by the processor to:
after a determination of the second path, directly modify the second entry of the second MAC table to specify an association between the MAC address of the first device and the fourth port of the second network switch.

4. The computing device of claim 1, wherein the instructions are executable by the processor to:
detect the pause condition at the first port based on a Simple Network Management Protocol (SNMP) message from the network switch.

5. The computing device of claim 4, wherein the network switch sends the SNMP message in response to a priority pause frame received from a fifth port of a third network switch, wherein the fifth port is included in the first path between the first device and the second device.

6. The computing device of claim 1, wherein the instructions are executable by the processor to, after the detection of the pause condition:
in response to a determination that the pause condition has ended at the first port of the network switch, modify the first entry of the MAC table to specify the association between the MAC address of the second device and the first port.

7. The computing device of claim 1, wherein the network topology is stored in the machine-readable storage medium.

8. A non-transitory machine-readable storage medium storing instructions that upon execution cause a processor to:
detect, by a network management device, a pause condition at a first port of a network switch, wherein the first port is included in a first path that is transmitting data between a first computing device and a second computing device, and wherein a first entry of a media access control (MAC) table of the network switch specifies an association between a MAC address of the second computing device and the first port;
in response to a detection of the pause condition, determine, by the network management device, a second path between the first computing device and the second computing device that is not being used to transmit data, wherein the second path includes a second port of the network switch; and
modify, by the network management device, the first entry of the MAC table to specify an association between the MAC address of the second computing device and the second port.

9. The non-transitory machine-readable storage medium of claim 8, wherein the first path includes a third port of a second network switch, wherein the second network switch includes a second MAC table, and wherein a second entry of the second MAC table specifies an association between a MAC address of the first computing device and the third port of the second network switch.

10. The non-transitory machine-readable storage medium of claim 9, wherein the second path includes a fourth port of the second network switch, and wherein the instructions cause the processor to:
after a determination of the second path, modify the second entry of the second MAC table to specify an association between the MAC address of the first computing device and the fourth port of the second network switch.

11. The non-transitory machine-readable storage medium of claim 8, wherein the instructions cause the processor to:
detect the pause condition at the first port based on a Simple Network Management Protocol (SNMP) message from the network switch.

12. The non-transitory machine-readable storage medium of claim 11, wherein the network switch sends the SNMP message in response to a priority pause frame received from a fifth port of a third network switch, wherein the fifth port is included in the first path between the first computing device and the second computing device.

13. The non-transitory machine-readable storage medium of claim 8, wherein the instructions cause the processor to, after the detection of the pause condition:
in response to a determination that the pause condition has ended at the first port of the network switch, modify the first entry of the MAC table to specify the association between the MAC address of the second computing device and the first port.

14. The non-transitory machine-readable storage medium of claim 8, wherein the instructions cause the processor to:
determine the second path based on a stored network topology.

15. A computer implemented method, comprising:
receiving, by a network management device, a notification of a pause condition detected at a first port of a network switch, wherein the first port is included in a first path that is transmitting data between a first computing device and a second computing device, and wherein a first entry of a media access control (MAC) table of the network switch specifies an association between a MAC address of the second computing device and the first port;
in response to the notification of the pause condition, determining, by the network management device, a second path between the first computing device and the second computing device that is not being used to transmit data, wherein the second path includes a second port of the network switch; and
modifying, by the network management device, the first entry of the MAC table to specify an association between the MAC address of the second computing device and the second port.

16. The computer implemented method of claim 15, wherein the first path includes a third port of a second network switch, wherein the second network switch includes a second MAC table, and wherein a second entry of the second MAC table specifies an association between a MAC address of the first computing device and the third port of the second network switch.

17. The computer implemented method of claim 16, comprising:
after a determination of the second path, modifying, by the network management device, the second entry of the second MAC table to specify an association between the MAC address of the first computing device and a fourth port of the second network switch, wherein the fourth port is included in the second path.

18. The computer implemented method of claim 15, comprising:
detecting, by the network management device, the pause condition at the first port based on a Simple Network Management Protocol (SNMP) message from the network switch.

19. The computer implemented method of claim 18, comprising:
receiving, by the network switch, a priority pause frame from a fifth port of a third network switch, wherein the fifth port is included in the first path between the first computing device and the second computing device; and
sending, by the network switch, the SNMP message in response to a receipt of the priority pause frame.

20. The computer implemented method of claim 15, comprising:
after receiving the notification of the pause condition, determining that the pause condition has ended at the first port of the network switch; and
in response to a determination that the pause condition has ended at the first port of the network switch, modifying the first entry of the MAC table to specify the association between the MAC address of the second computing device and the first port.
